(19) United States
(12) Patent Application Publication
(10) Pub. No.: US 2009/0319188 A1
(43) Pub. Date: Dec. 24, 2009

(54) METHOD FOR GENERATING A LOCATION REFERENCE AND METHOD FOR MAPPING INFORMATION TO A POSITION WITHIN A DIGITAL MAP DATABASE

(75) Inventor: Hans Ulrich Otto, Hildesheim (DE)

Correspondence Address: HARNESS, DICKEY & PIERCE, P.L.C., P.O. BOX 8910, RESTON, VA, 20195, US

(73) Assignee: TELEATLAS N.V., 's-Hertogenbosch (NL)

(21) Appl. No.: 12/309,472

(22) PCT Filed: Jul. 21, 2006
(86) PCT No.: PCT/NL2006/050185

§ 371 Date: May 26, 2009

(51) Int. Cl. G06F 17/30

(52) U.S. Cl. 701/300

(57) ABSTRACT

Method for generating a location reference and method for mapping information to a position within a digital map database are disclosed. At least one embodiment of the invention relates to a method for generating a location reference for mapping information to a position within a digital map database. The digital map database includes map objects having unique map object references associated therewith. The method includes: selecting a map object in the digital map database based on the information, selecting a unique map object reference of the selected map object, generating the location reference including the unique map object reference of the identified map object. The method further includes: determining a relative position of the position in the digital map database the information relates to with respect to the selected map object, and the location reference further includes the relative position.

### TECHNICAL FIELD

The present invention relates to a method for generating a location reference and method for mapping information to a position within a digital map database.

### BACKGROUND

Historically, documents were printed on paper or other non-modifiable, non-interactive media, and did not allow any user modification of the information or of relationships between data points. Moreover, documents could not be updated when new information appeared, and the databases in the modern sense of the word did not even exist, rendering the concept of updating them moot.

Prior to the computer age, there were essentially two forms of recourse when a map needed modification: 1) to enter a correction by hand on the paper copy; or 2) to reprint the map with the correction made on the original. Manual corrections are time-intensive, particularly for multiple modifications, and by definition do not update any of the other outstanding copies of the map. The option of reprinting the map is expensive and also an impractical way to respond to frequent modifications.

In the current age, we have databases, documents, and maps in digital, electronic formats, capable of being updated as desired and able to respond to a selected range and type of operator input and to produce operator-requested output. Many electronic documents and electronic databases in common usage today comprise information related to geographic location(s). Indeed, it is not necessarily easy to think of a class of electronic documents or a class of electronic databases that does not at least occasionally incorporate some form of geographically related information.

One example of electronic databases that is relevant to certain embodiments of the invention is geospatial databases, known for convenience and intuitive comprehensibility as electronic maps or digital map databases. In the current computer age, maps have evolved well beyond their centuries-old status as static paper depictions of a non-adjustable data set as recorded at one particular time. For simplicity, much of the discussion below refers to electronic maps, although the points made also apply to electronic documents and electronic databases other than maps that contain geographic information. In this application, the term digital map database is used to denote all kinds of electronic and digital maps.

One of the great benefits of a digital map database over a traditional paper-based map is its inherent flexibility and ability to portray large amounts of data. Paper maps are necessarily limited in the amount and type of information they can portray, within the constraints of their physical formats. Paper maps are also difficult to update.

Digital map databases do not suffer from these problems. While earlier digital map databases may have seemed merely like a scanned version of the paper product, today's modern digital map databases are much more powerful. Information can be included in the map and either displayed, or not displayed, depending on the wishes of the operator.

Today's digital map databases, also known as electronic maps, can allow for regular modification of data points included in the map as well as active operator selection of desired geographic features of interest. As new information arises, of a type specifically relevant to a map of interest or a point of interest in the map, the map can be quickly updated to reflect changes or corrections to all or just a small subset of locations.

An important feature of digital map databases is that digital map databases can easily be modified, i.e. by changing existing data or adding new data. For instance, third party information (e.g., a database comprising list of hotels with locations of the hotels) can be added to the digital map database. In order to do this, the third party information needs to be linked to the digital map database, i.e. for any given third party information or data the corresponding location as well as related spatial object(s) in the digital map database are identified. This process is called location referencing.

A simple known location referencing scheme uses coordinates of the digital map database to reference to a location within a digital map database. This is a relatively straightforward, compact and flexible way of referencing to any kind of location and database. However, it is also unreliable and ambiguous, because it only works between maps with substantially the same geometry. Different maps may typically be created from different sources and thus may have different geometric accuracies and content. As a consequence, the same real-world object may have different coordinates in different maps, and when overlapping different maps an (sometimes quite significant) offset may occur.

Another known method for location referencing uses identification codes in a lookup table that is stored in a database. This is also a compact, reliable method that may be used to refer to pre-defined locations. However, this method is inflexible as it may only be used for pre-defined locations. Also, maintenance is very difficult for map providers, as the lookup table stored in an existing digital map database. For example in case of the popular Traffic Message Channel (TMC) tables in Europe, these are under control of the road authorities, which decide where and when to put a new location. One of these tables is a location table having a size limited to 65535 locations. After releasing a new version of a TMC table, in order to make the system work properly, all players in the traffic service chain need to update their location table, i.e. the map supplier, the navigation system vendor, the traffic management centres, the broadcast stations, and the private users of a navigation system. From a logistical point of view this is complicated.

Another method for location referencing uses an algorithmic approach using only a database with information from the map provider. For example, the popular AGORA method uses several map properties to create a robust reference code, e.g. one or more coordinates, object names and classifications, topology between objects etc. This is a flexible method (although known methods are only proven for point objects and road network). It requires rather long codes and is therefore not compact. It has a high reliability, but the reliability is less than 100%. The method requires running certain software tools at encoder sides which puts some burden on clients in terms of processing power and required system resources. E.g. the system needs to perform a route calculation, and map matching. Such functionality requires a certain system profile and processing time. Therefore, this method is not optimal for use in ‘thin clients’, such as mobile phones.

### SUMMARY

There is provided a method for generating a location reference for mapping information to a position within a digital map database, the digital map database comprising map objects, having unique map object references associated therewith, the method comprising:

selecting a map object in the digital map database based on the information,

extracting a unique map object reference of the selected map object,

generating the location reference comprising the unique map object reference of the identified map object, wherein the method further comprises:

determining a relative position of the position in the digital map database the information relates to with respect to the selected map object, and the location reference further comprises the relative position.

According to an embodiment the selected map object in the digital map database is the map object in the digital map database that is nearest to the position in the digital map database the information refers to.

According to an embodiment the relative position may be zero, indicating that the position in the digital map database the information refers to coincides with the selected map object or the distance between the position in the digital map database the information refers to and the selected map object is below a predetermined threshold.

According to an embodiment the relative position of the information with respect to the identified map object is expressed in a distance from the selected map object and an angle identifying a direction from the selected map object.

According to an embodiment the relative position of the information with respect to the selected map object is expressed in a first distance from the selected map object in a first direction and a second distance from the selected map object in a second direction, the first direction being different from the second direction.

According to an embodiment the method further comprises determining a scale factor taking into account a scale difference between the digital map database and the information, and the location reference further comprises the scale factor.

According to an embodiment the method further comprises determining a rotation factor taking into account a rotational difference between the digital map database and the information, and the location reference further comprises the rotation factor.

According to an embodiment the selected map object is a line feature, the information is coinciding with a fraction of this line feature and the location reference comprises an indication of the fraction of the line feature the information coincides with.

According to an embodiment the indication of the fraction of the line feature the information coincides with is expressed in a first offset from a start node or from an end point of the selected map object and/or in a second offset from the start node or from the end point of the selected map object along the line feature.

According to an embodiment more than one line feature is selected, and the indication is with respect to a first selected line feature and with respect to a second selected line feature.

According to an embodiment the unique map object reference of the selected map object comprises a feature identification.

According to an embodiment the unique map object reference of the selected map object further comprises a feature class reference.

According to an embodiment the location reference further comprises header information, wherein the header information may comprise a version reference and a database reference.

According to an embodiment the location reference further comprises an external location type, identifying if the information relates to a point, such as a point of interest, a line, such as a road element, or an area, such as a country.

According to an embodiment the selected map object is one of a point feature, such as a point of interest junction, a line feature such as a road element and an area feature such as an administrative area, etc.

According to an embodiment the method further comprises:

selecting a reference point for the information, relative to which the location reference is generated.

Furthermore, there is provided a method for generating a location based message, the location based message comprising a message content based on the information and a location reference, where the location reference is generated as described above.

According to an embodiment the method further comprises transmitting the location based message to at least one client computer system.

Furthermore, there is provided a method for mapping information to a position within a digital map database, the digital map database comprising map objects having unique map object references associated therewith, the method comprising:

loading a location reference comprising a unique map object reference of a map object,

identifying a map object in the digital map database based on the unique map object reference,

mapping the information to the digital map database based on the location reference, wherein the location reference further comprises a relative position, and the method further comprises:

identifying the position within the digital map database based on the identified map object in the digital map database and the relative position.

According to an embodiment the method further comprises identifying a scale factor from the location reference taking into account a scale difference between the digital map database and the information, and applying the scale factor.

According to an embodiment the method further comprises identifying a rotation factor from the location reference taking into account a rotational difference between the digital map database and the information, and applying the rotation factor.

According to an embodiment the identified map object is a line feature, and wherein the location reference further comprises at least an indication of the fraction of the line feature the information coincides with and the method further comprises:

identifying the positions of a start point and an end point within the digital map database based on the identified map object in the digital map database and said at least indication.

According to an embodiment the indication of the fraction of the line feature of the information coincides with comprises a first offset from a start node or an end point of the line feature and/or a second offset from the start node or the end point of the line feature along the line feature.

According to an embodiment the location reference comprises more than one map object, and the indication is with respect to a start node of a first identified map object and with respect to a second identified map object.

Furthermore, there is provided a computer system for generating a location reference for mapping information to a position within a digital map database, the computer system comprising a processor unit and memory units, the processor unit being arranged to communicate with the memory units, the memory units being arranged to comprise a digital map database comprising map objects having unique map object references associated therewith, the computer system being arranged to

load information for which the location reference is to be generated,

select a map object in the digital map database based on the information,

select a unique map object reference from the digital map database on the selected map object,

generate the location reference comprising the unique map object reference of the identified map object, wherein the computer system is further arranged to:

determine a relative position of the information with respect to the selected map object, and the location reference further comprises the relative position.

Furthermore, there is provided a computer system arranged to map information to a position within a digital database, the computer system comprising a processor unit and memory units, the processor unit being arranged to communicate with the memory units, the memory units being arranged to comprise a digital map database comprising map objects having unique map object references associated therewith, the computer system being arranged to:

load a location reference comprising a unique map object reference of a map object,

identify a map object in the digital map database based on the unique map object reference, wherein the location reference further comprises a relative position and the computer system further is arranged to:

identify a position within the digital map database the information relates to based on the identified map object in the digital map database and the relative position.

Furthermore, there is provided a computer program, when loaded on a computer arrangement, is arranged to perform any one of the methods described above.

Furthermore, there is provided a data carrier, comprising a computer program according to the above.

The embodiments as presented here provide several advantages over the prior art. For instance, according to at least one embodiment no extra maintenance is required for the standard digital map database.

Also, according to at least one embodiment the required code size for executing the method is relatively low, at least smaller than the method for location referencing described above using an algorithmic approach using only a database with information from the map provider.

Also, according to at least one embodiment, there is less demand on decoding at the clients side, making it especially suitable for use by ‘thin clients’, such as (mobile) telephones, since only a map and map access functions are required.

According to at least one embodiment, there is provided a flexible solution for encoding any location.

Based on the above, the proposed embodiments seem especially useful in the wireless domain, where location references are transmitted wirelessly, since relatively small location references are generated, that may easily be transmitted, using relatively little transmission capacity. However it may also be applied in the field of navigation and/or Internet.

### BRIEF DESCRIPTION OF THE DRAWINGS

The present invention will now be discussed in more detail using a number of exemplary embodiments, with reference to the drawings, which are only intended to illustrate the present invention and not to limit its scope which is only limited by the appended claims:

FIG. 1 schematically depicts a computer system according to an embodiment,

FIGS. 2-8 schematically depict a digital map database according to an embodiment,

FIG. 9 schematically depicts a system according to en embodiment,

FIG. 10-13 schematically depict flow charts according to an embodiment.

### DETAILED DESCRIPTION

According to an embodiment, a method and system is provided that allows linking third party information to a digital map database. Of course, it will be understood that the term third party information relates to data that are not part of the digital map database. Usually such data is provided by a third party, i.e. a party that doesn't exploit the digital map database, but of course, it may also be provided by the owner/manufacturer of the digital map database. The third party information may for instance relate to:
a list of hotels including their locations,
a discount offer for a hotel as well as the menu for tonight,
a traffic jam on certain road element(s),
a thunderstorm in a certain area,
position of a public rest-room,
public transportation network lines.

However, the third party information may relate to all kinds of information.

According to an embodiment, a method and system is provided for referencing to a position in the digital map database. In order to do so, a location reference is generated.

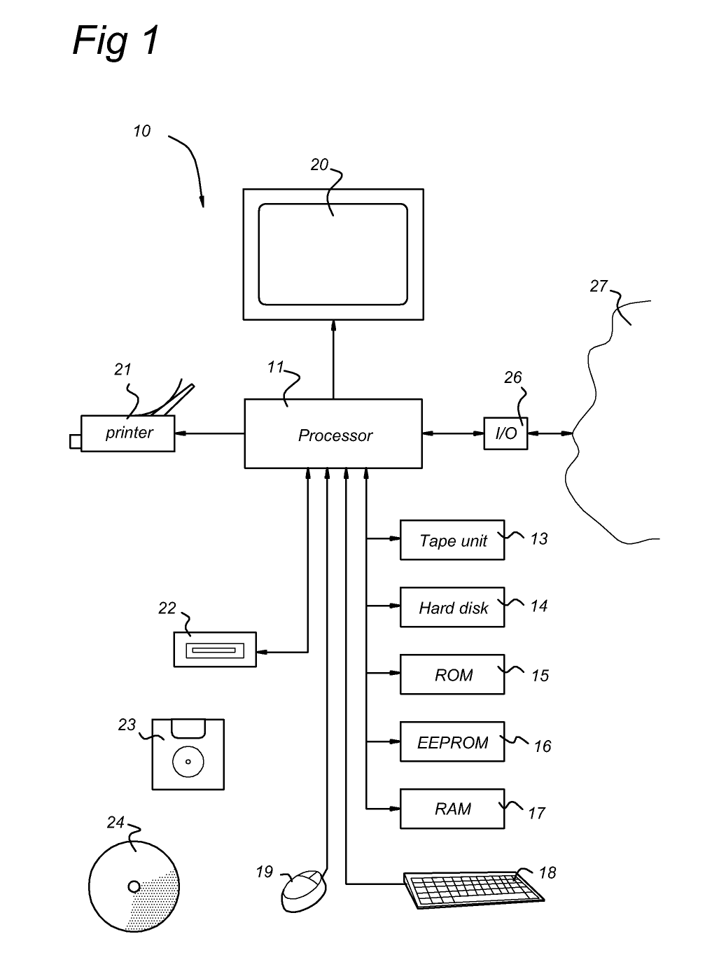

The detailed description comprises several descriptions, such as a description about linking third party information to a digital map database, encoding third party information into a location based message, comprising a location reference, decoding encoded third party information. All these aspects may be performed by or with the aid of a computer system 10. FIG. 1 shows a schematic example of an embodiment of such a computer system 10. It will be understood that the computer system 10 as described with reference to FIG. 1, may be used for the different aspects of the detailed description. The detailed description for instance discusses data being exchanged between a server computer system and a client computer system. Both the server computer system and the client computer system may be formed as a computer system 10 discussed below with reference to FIG. 1.

General Description of Computer System

FIG. 1 shows a schematic block diagram of an embodiment of a computer system 10, comprising a processor unit 11 for performing arithmetical operations. The processor unit 11 may be connected to memory units that may store instructions and data, such as a tape unit 13, a hard disk 14, a Read Only Memory (ROM) 15, an Electrically Erasable Programmable Read Only Memory (EEPROM) 16 and a Random Access Memory (RAM) 17. The processor unit 11 may also be connected to one or more input devices, such as a keyboard 18 and a mouse 19, one or more output devices, such as a display 20 and a printer 21, and one or more reading units 22 to read for instance floppy disks 23 or DVDs or CD ROMs 24. In an embodiment the computer system 10 comprises a database stored in said memory units 13, 14, 15, 16, 17 containing a digital map database and/or program instructions readable for the processor unit 11 to perform the embodiments described below.

The computer system 10 shown in FIG. 1 also comprises an input-output device (I/O) 26 that is arranged to communicate with other computer systems (not shown) via a communication network 27.

However, it should be understood that there may be provided any number of memory units, input devices and read devices known to persons skilled in the art. Moreover, one or more of them may be physically located remote from the processor unit 11, if required. The processor unit 11 is shown as one box, however, it may comprise several processor units functioning in parallel or controlled by one main processor unit that may be located remote from one another, as is known to persons skilled in the art.

It is observed that, although all connections in FIG. 1 are shown as physical connections, one or more of these connections can be made wireless. They are only intended to show that “connected” units are arranged to communicate with one another in someway.

The computer system 10 is shown as a computer system, but can be any signal processing system with analog and/or digital and/or software technology arranged to perform the functions discussed here.

In examples below, computer systems, such as a server computer system and a client computer system are shown and explained in a more schematic way. The computer systems may be any type of computer system, and also include in-vehicle navigation systems, (portable) personal navigation systems, mobile telephones, personal digital assistants (PDA), smart telephones having a storage medium arranged to comprise a digital map database.

A third party may have information that is to be added to a digital map database, or at least is to be used in combination with the digital map database. The third party information may for instance be “there is a traffic jam on the motorway 42 between exit 12 and exit 14”. This message comprises two parts:

1) “what” (there is a traffic jam) and

2) “where” (motorway 42 between exit 12 and exit 14).

This third party information is for instance to be encoded at a server computer system. After encoding, the third party information may be transmitted to a client computer system, such as a navigation device. The client computer system may decode the received third party information, so it may be used in the client computer system to navigate around the traffic jam.

As will be explained in more detail below, the “where” is encoded into a location reference using the digital map database and the “what” is stored into a message content. Both the “what” and the “where” part are used to compose a location-based message that may be added to or used in combination with the digital map database.

The “where” part may be encoded into a location reference using a digital map database stored at the server computer system, that is similar to the digital map database stored at the client computer system.

For instance, the location-based message may be transmitted to the client computer system, such as a navigation device. Upon receiving, the client computer system may decompose the location-based message into the location reference and the message content. The location reference can be decoded using the digital map database stored in the client computer system. This results in the original message comprising the “what” and “where”.

As will be explained in more detail below, a location reference is generated to encode the “where” part of the third party information. This may be done at a server computer system. The encoding is done using a digital map database stored at the server computer system. By using features of the digital map database that are unique for that particular digital map database, the location reference may only be used by a client computer system that has a similar digital map database stored in it.

In reality, two map databases X and Y however may differ in their data model as well as their content. For example, map database X may be produced from a map supplier company at a certain point in time while map database Y was produced at a later time and thus includes several changes on the road network that have happened in reality, e.g. a new road was build, new hotels and restaurants have been opened.

Using the location reference as explained above and as will be explained in more detail below, third party information may be transmitted from a server computer system to a client computer system. Since the location reference uses unique features of the digital map database, a client computer system can only decode the location reference, if it has a similar digital map database stored in it.

This type of technology may be applied for delivery of dynamic traffic information. This technology may replace existing methods of providing traffic information, such as TMC (traffic message channel). The technology may be useful to provide traffic information in places where TMC is not available (typically inner-city traffic), but it may also replace TMC completely on long-term.

Of course, the technology may also be used for transmitting other third party information types from a first computer system to a second computer system.

Based on the above it is explained that third party information may be encoded into a location reference (“where” part) and a message content (“what” part), together forming a location-based message. Below, the location reference is explained in more detail.

The Location Reference

The third party information may be encoded using a server computer system, such as for instance a computer system 10 as described with reference to FIG. 1. First a description is given of a possible format of the encoded third party information.

According to an embodiment, the location reference may comprise the following items:
version reference,
database reference,
external location type,
feature class reference,
feature identification,
relative position.

In general, the location reference may comprise a unique reference to a map object in the digital map database, as well as information about the relative position of the third party information, relative to the uniquely identified object.

Version Reference

The location reference may comprise a version reference, being an indication what version of location referencing is used. Such a version reference may be added to the location reference to indicate what version or type of location referencing is used to generate the location reference. This may help the client computer system to decode the location reference successfully.

Database Reference

The location reference may further comprise a database reference. This database reference indicates relative to which digital map database the location reference has been generated. For instance, in case a supplier of digital map databases manufactures and/or maintains more than one different digital map databases, the location reference may comprise a reference indicating for which digital map database or series of digital map databases the location reference may successfully be used.

External Location Type

Also an external location type may be added to the location reference. Such an external location type may be an indication of the type of third party location that is to be encoded. Examples of different external location types are: 1) point, 2) line and 3) polygon.

For instance, if the third party information relates to a hotel, the external location type may be a—1—indicating that the location reference relates to a point, i.e. the position of the hotel. If the third party information relates to a road or a border, the external location type may be a—2—indicating that the location reference relates to a line. If the third party information relates to an area, such as a country or a region, the external location type may be a—3—indicating that the location reference relates to an area, such as e.g. a polygon. Of course, these are just examples. It will be understood that also other external location types may be encoded and also, other codes may be used to encode the different external location types.

Feature Class Reference,

A feature class reference may be added to the location reference to indicate the class the object in the digital map database belongs to with respect to which the third party information is referenced to. These feature class references may be a number, for instance according to standard GDF feature codes (ISO 14825:2004(E)). Examples of feature class references are (topics within brackets are examples of information that may be added to the message content):

| Feature Class | Description (added content topics) |
|---|---|
| 7314 | hotel/motel (room prices) |
| 4110 | road element (traffic) |
| 3110 | built-up area (weather) |
| 4130 | ferry connection (time table) |
| 7315 | restaurant (menu) |
| 7373 | shopping centre (daily offers) |
| 7385 | exhibition centre (event) |
| 7356 | airline (flight schedule) |

Of course, other features classes may be encoded and also, other feature class references may be used to encode different feature classes.

Feature Identification

Furthermore, a feature identification may be added to the location reference. Map objects already comprised by the digital map database may comprise a feature identification. Such a feature identification may be just a number (e.g. 48), uniquely identifying the map object.

In fact, such a map object may be all kinds of map objects from the digital map database that have such a unique identification. The map object may be a Point of Interest (POI), such as a museum, a hotel, but may also be a start node or end node of a road element. In fact, any kind of map object in the digital map database that has a unique identifier may be used for generating a location reference.

When generating a location reference, the choice of map object relative to which the location reference is generated depends on the situation. For instance, if the third party information to be linked to the digital map database is supplementary to an already existing map object, the third party information may directly be pinpointed to the map object. In case the third party information is an object on its own, the third party information may be linked relative to a road network point.

In order to encode the position of third party information, a near(est) map object that has an unique identification in the digital map database may be identified, and the feature identification of this near map object is added to the location reference. This will be explained in more detail below. The advantage of using the nearest map object is that the location reference will be more compact, as the numerical distance value between the third party information and the map object will be minimal and thus as compact as possible. Of course, also an object may be selected that is not the nearest object.

In order to prevent mistakes, the feature identification should be unique, so only occurring once in a digital map database. According to an embodiment, the feature identification only needs to be unique for a feature class reference.

Of course, the position of the third party information doesn't necessarily coincide with the position of the near feature in the digital map database. Therefore, one more item may be added to the location reference.

Relative Position

In case the position of the third party information doesn't coincide with the position of the near map object in the digital map database, the relative position with respect to the position of the near map object in the digital map database is determined and added to the location reference. There are many different ways to express the relative position.

For instance, the relative position of the third party information with respect to a feature in the digital map database may be expressed by adding a distance and an angle to the location reference. The distance may for instance be expressed in metres (e.g. 38 metres) identifying the distance between the third party information and the near map object or the start node of the near map object in the digital map database. The angle may be expressed in degrees (e.g. 315° degrees from north, clockwise, taking the position of the near map object in the digital map database as origin).

Of course, the relative position may also be expressed in other ways, for instance by providing two distances, where the first distance indicates the relative position of the third party information with respect to the near map object to the north, and the second distance indicates the relative position of the third party information with respect to the near map object to the east. So, in that case, 38, −41 indicates that the third party information is 38 metres to the north and 41 metres to the west with respect to the identified near map object. According to this embodiment, the distances are expressed in meters, however, it will be understood that any other suitable and agreed upon unit may be used, such as yards or feet.

Another way to express a relative position is, if the near map object is one or more line features, e.g. road element(s), and the complete location reference does completely overlap but is only a subset of the map object(s). In this case the relative position may be specified as start offset from the start node of the first map object and end offset from the start node of the last map object. The unit for the offsets may be a percentage of the total length of the respective map object. For example, 24, 58 indicates that the start of the third party information is 24% of the total length of the underlying map object away from its start node, while the end of the third party information is 58% of the total length of the underlying map object away from its start node.

To further clarify the above explanation, a few examples will be given here.

### Example 1

According to a first example, a third party provider has information of actual discount offers for a hotel as well as the menu for tonight. The hotel the third party information relates to is already in the digital map database.

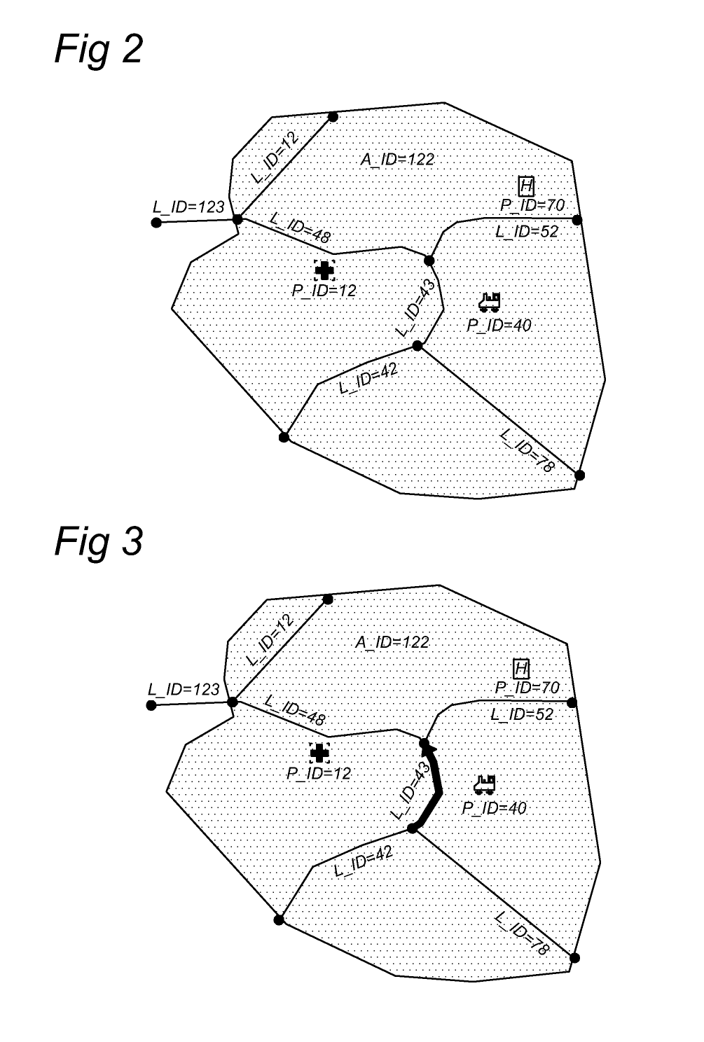

FIG. 2 schematically depicts (a part of) a digital map database for which a location reference for this information is generated. FIG. 2 shows different points (e.g. P_ID=12), line elements (e.g. L_ID=48) and areas (e.g. A_ID=222). FIG. 2 also comprises a point with feature identification 70, being the hotel to which the third party information relates to.

Thus, in this case the location reference may be: 1 2005.1 1 7314 70, wherein:

version reference=1;

database reference=2005.1;

external location type=1 (point);

feature class reference=7314 (hotel/motel);

feature identification=70.

Since the hotel the third party information relates to is already in the digital map database, the hotel coincides with an already existing feature of the digital map database. Therefore, no relative position needs to be added to the location reference.

According to an alternative, the relative position may be added to the location reference by adding zeroes. If, for instance, the relative position is expressed with a distance and angle, the distance could be zero, and the angle could be any value.

Based on this location reference it can be seen that the location reference is generated with a version 1 (version reference=1) location referencing method and can be used for a database having a reference 2005.1 (database reference=2005.1), being for instance the first version of a digital map database made in the year 2005.

The external location type 1 indicates that the location reference refers to a point. Based on the feature class reference 7314 it can be seen that the location reference refers to a hotel or motel. Based on the feature identification 70 the exact position can be identified in the digital map database, i.e. the position associated with the feature having 70 as a unique identifier.

Based on the above, it can be seen that the location reference uniquely and unambiguously points to a position in a digital map database. In case the third party information (discount offers/menu) is to be added to the digital map database, the location reference can be used to point to the relevant position within the digital map database.

### Example 2

According to a second example, a third party provider has information of a traffic jam matching a road element already in the digital map database.

FIG. 3 schematically depicts (a part of) a digital map database for which a location reference for this third party information is to be generated. FIG. 3 shows the same (part of) the digital map database as FIG. 2, comprising the same elements and reference numbers. In this case, the location reference may be: 1 2005.1 2 4110 43, wherein:

version reference=1;

database reference=2005.1;

external location type=2 (line);

feature class reference=4110;

feature identification=43.

Again, the position for which the location reference is generated is already identified in the digital map database, so no relative position needs to be added to the location reference.

Different than example 1, the location reference now indicates that the external location type 2 is for a line, and not a point. Also, the feature class reference indicates that the location reference refers to a road element. Based on the feature identification it can be concluded that the location reference refers to the road element having as unique feature identification 43. The road element having feature identification 43 is printed bold in FIG. 3.

So, the above location reference may be used to communicate traffic information to a digital map database, where the location reference uniquely and unambiguously provides information about the location of the traffic information within the digital map database. In this example, it is assumed the traffic jam occurs in both directions of the referenced road element. In case a traffic jam only applies to one direction of a road element, another location reference may be specified, e.g. as shown in following Example 3. According to example 3, the location reference has an implied orientation (i.e. from start offset to end offset) and thus can describe the validity direction of the information in the message content.

### Example 3

According to a further example, the location reference may be: 1 2005.1 2 4110 78 43 52 85 50, wherein:

version reference=1;

database reference=2005.1;

external location type=2 (line);

feature class reference=4110 (road element);

feature identification=78 43 52;

relative position=85% start offset, 50% end offset.

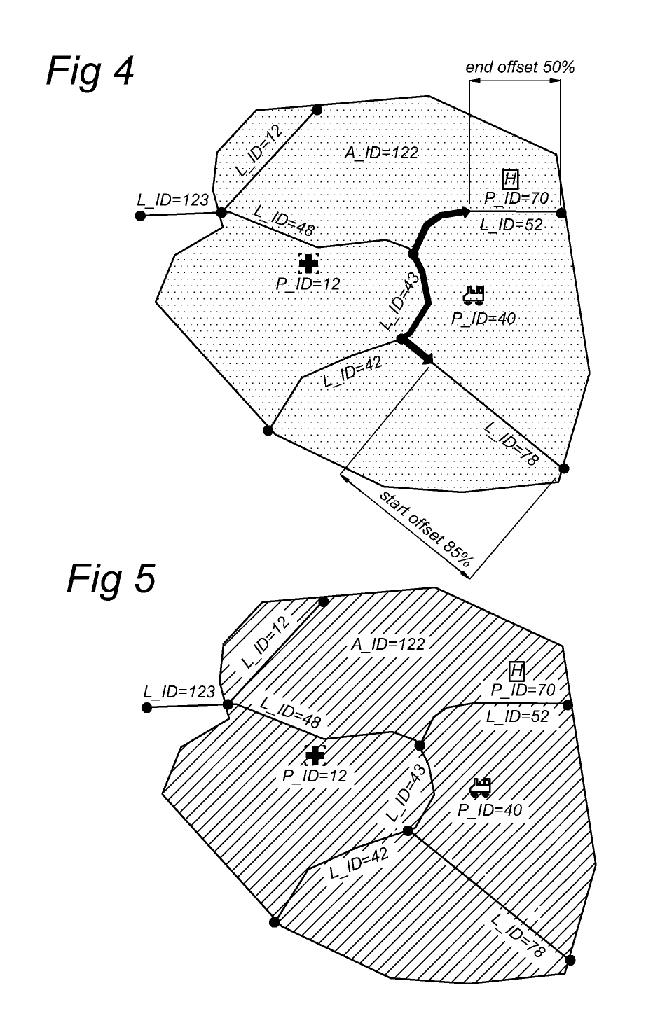

This location reference is similar to example 2, except for the fact that three feature identifications are provided, indicating that the traffic jam is on three road elements, having feature identifications 78 43 and 52 and except that the location reference starts somewhere in the middle of road element 78 and also ends somewhere in the middle of road element 52. The offsets indicate the precise start and end points of the location reference. In the example, the start offset 85% means, that the start point of the location reference has a distance of 85% of the total length from the start node of the first line feature 78 in the list. The end offset 50% means, that the end point of the location reference has a distance of 50% of the total length from the start node of the last line feature 52 in the list. The location reference is printed bold in FIG. 4.

In case even more feature identifications are to be added to the location reference, the location reference may grow significantly. To reduce the length of the location reference, not the complete list of feature identifications may be included into the location reference but only start, end and relevant middle feature identifications, necessary to unambiguously determine the topologically connected chain. At every decision point additional objects need to be included to make the topological chain unique gain.

So, according to an embodiment, the selected map object may be a line feature and the information that is to be encoded coincides with a fraction of this line feature. In such a case, the location reference may comprise an indication of the fraction of the line feature the information coincides with. Such an indication of the fraction of the line feature the information coincides with may be expressed in a first offset from a start node or from an end point of the selected map object and/or in a second offset from the start node or from the end point of the selected map object along the line feature.

Also, in case more than one line feature may be selected. In that case the indication may be with respect to a first selected line feature and with respect to a second selected line feature.

### Example 4

According to a further example, a third party is a weather provider, notifying that there is a heavy thunderstorm in a certain area, for which the digital map database already has a corresponding feature identification. In this example the location reference may be 1 2005.1 3 3110 222, wherein:

version reference=1;

database reference=2005.1;

external location type=3 (area);

feature class reference=3110 (built up area);

feature identification=222.

Based on this location reference, it can be understood that the location reference refers to an area, and not to a point or line, as the external location type equals 3. The area may for instance be a polygon, determined by a number of points. The feature class reference 3110 indicates that the location reference refers to a built up area, being an area that is already present in the digital map database. Finally, the location reference comprises a feature identification 222 uniquely identifying the area. FIG. 5 shows the area the location reference points to as a shaded area.

### Example 5

According to a further example, a third party provider has information about the location of a public rest-room. However, in this case, the position of the public rest-room doesn't coincide with a map object in the digital map database already having a unique feature identification. According to this example, the location reference may be: 1 2005.1 1 4110 48 37 315, wherein

version reference=1;

database reference=2005.1;

external location type=1 (point);

feature class reference=4110 (road element);

feature identification=48;

relative position=37 metres, 315°.

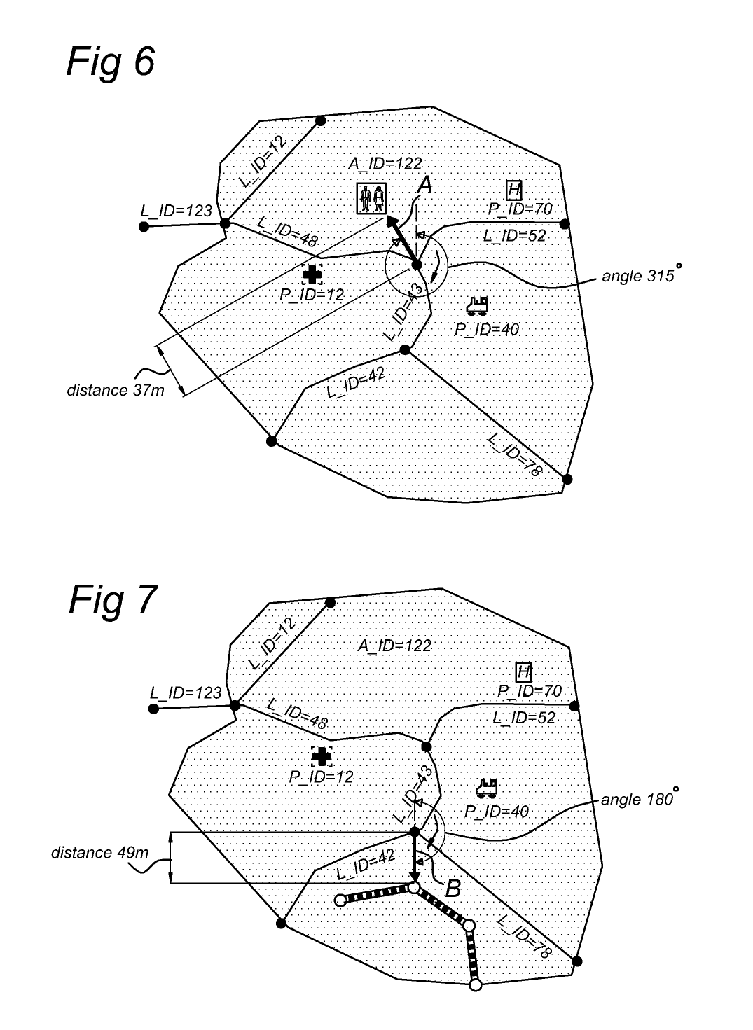

As will be understood, the location reference uniquely points to a position of the rest-room, therefore, the external location type is 1. The location reference further comprises a feature class reference being 4410 and a feature identification being 48, referring to a road element having as unique feature identification 48. This road element is shown in FIG. 6.

Next, the relative position is determined by a distance and an angle. The distance is 37 metres and the angle is 315°. The distance is 37 metres away ‘as the crow flies’ from start node of road element 48. The angle is 315° from north, clockwise, taking the start node of road element 48 as origin. These two parameters uniquely identify the position of the public rest-room relative to the start node of road element 48. This is shown in more detail in FIG. 6, with arrow A.

It will be understood that the relative position may be indicated in different ways, as explained in the examples. The kind of relative position indication used may be added to the code, for instance in the header information. Also other known techniques may be used to distinguish between different ways to indicate a relative position, for instance using binary coding, in which the position of bits identifies the type of relative position indicators used. It will be understood that the code used in this text (such as 1 2005.1 1 4110 48 37 315) is just a logical representation and does not necessarily represent the exact way the code is represented in digital format.

### Example 6

According to a further example, a third party supplier has information concerning public transportation network lines for which a location reference is to be generated to add this information to the digital map database. The public transportation network lines together form a geometry.

In this example, the scale and rotational orientation of the public transportation network lines match the scale and rotational orientation of the digital map database. So, the whole third party geometry may simply be shifted to the right position in the digital map database. Therefore, a location reference is to be generated for one point of the third party geometry. The rest of the third party geometry may be placed relative to this position.

In practice this means that the whole third party geometry (public transportation network) is shifted to the correct position using the location reference. In this example, the location reference may be: 1 2005.1 2 4110 42 49 180, in which:

version reference=1;

database reference=2005.1;

external location type=2 (line);

feature class reference=4110 (road element);

feature identification=42;

relative position=49 metres, 180°.

Based on this location reference, a position can be identified within the digital map database, being 49 metres (‘as the crow flies’) to the south (180°) from the start node of road element 42. This is further shown in FIG. 7, with arrow B.

According to an alternative embodiment, the third party geometry may have a different scale and/or orientation, for instance resulting from a different accuracy of the map source. In this case the location reference may be extended with two additional parameters, i.e. a scale factor and a rotation factor.

Based on such a location reference, the third party geometry is then shifted to the correct position within the digital map database, and scaled and rotated based on the scale and rotation factor.

The location based message may further comprise an indication to which point of the added geometry the reference is made to. Such an indication may for instance be comprised in the message content.

The third party geometry may be scaled using the scale factor to match the scale of the digital map database. Also, the third party geometry may be rotated based on the rotation factor in order to match rotational orientation of the digital map database.

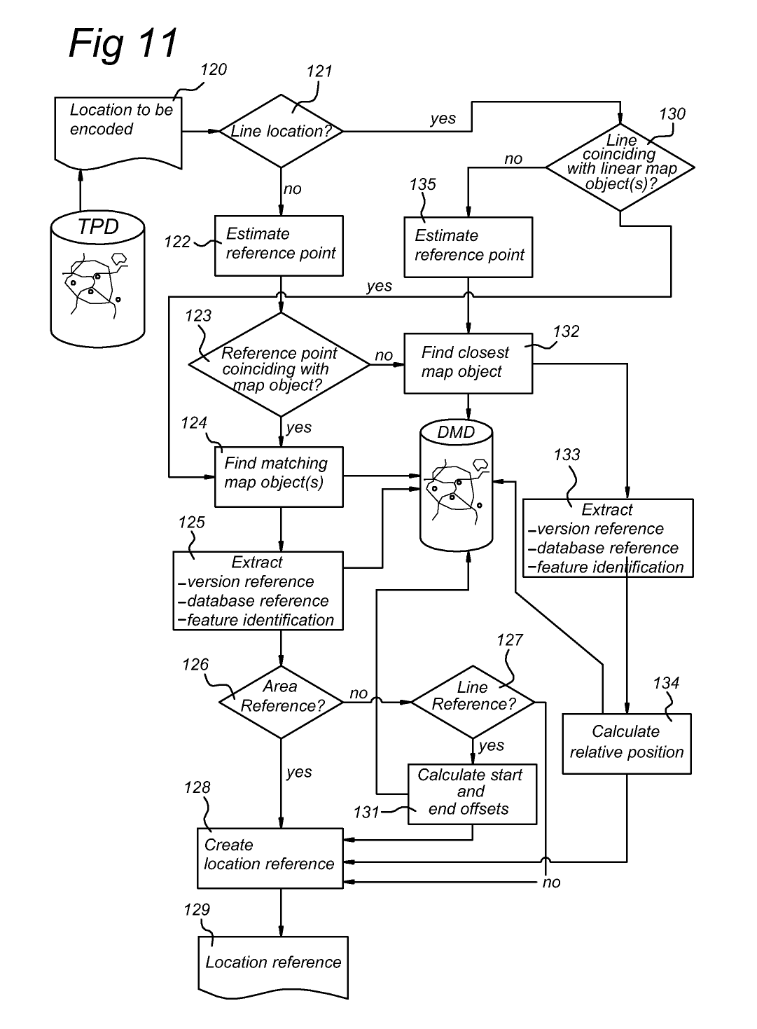

The reference point needs to be specified, which is further explained with reference to actions 122 and 135 in FIG. 11.

### Example 7

In a further embodiment, a third party has weather information for a certain area.

Again, if the scale and rotational orientation of the third party information matches the scale and rotational orientation of the digital map database, the location reference may simply refer to a certain position within the digital map database, indicating the shift of the third party information.

In that case, the whole third party geometry may simply be shifted to the right position in the digital map database. Therefore, a location reference is to be + for one point of the third party area. The rest of the third party area may be positioned relative to this position.

The location reference may be: 1 2005.1 3 4110 42 49 180, in which:

version reference=1;

database reference=2005.1;

external location type=3 (area/polygon);

feature class reference=4110 (road element);

feature identification=42;

relative position=49 metres, 180°.

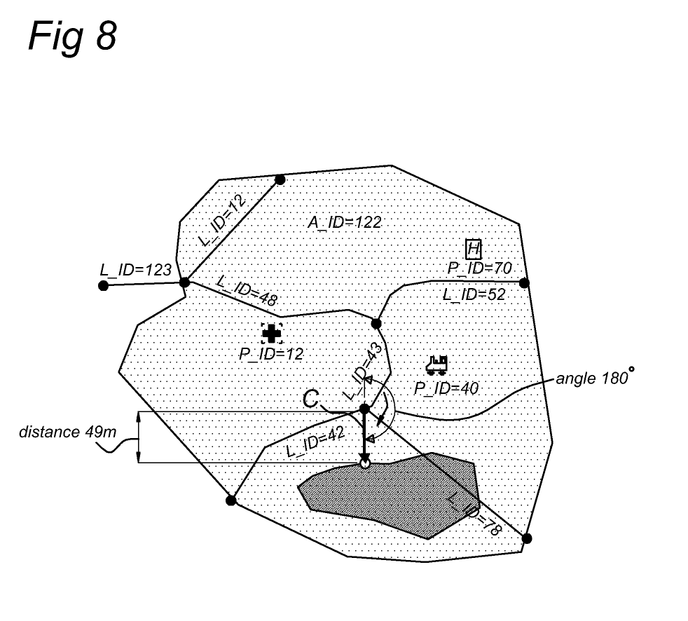

Based on this location reference, a position can be identified within the digital map database, being 49 metres (‘as the crow flies’) to the south (180°) from the start node of road element 42. This is further shown in FIG. 8, with arrow C.

According to an alternative embodiment, the third party geometry may have a different scale and/or orientation for instance resulting from a different accuracy of the map source. In this case the location reference may be extended with two additional parameters, i.e. a scale factor and a rotation factor.

Based on such a location reference, the third party area is then shifted to the correct position within the digital map database, and scaled and rotated based on the scale and rotation factor. The third party area may be scaled using the scale factor to match the scale of the digital map database. Also, the third party area may be rotated based on the rotation factor in order to match rotational orientation of the digital map database.

So, according to an embodiment, a scale factor may be determined, taking into account a scale difference between the digital map database and the information. Also, a rotation factor may be determined, taking into account a rotational difference between the digital map database and the information. The location reference may further comprise the scale factor and/or the rotation factor.

Based on the above, it will be understood that a location reference is a tool for mapping third party information to a digital map database. The location reference does usually not comprise the actual third party information (e.g. hotel info, traffic info, weather info etc.), but may form a location based message, together with a content message.

In general it will be understood that the location reference comprises information to uniquely identify a location within the digital map database, forming the “where” part of the location-based message, which may further comprise a “what” part, i.e. the message content. The location reference therefore comprises a unique map object reference to a map object in the digital map database, and, if required, the relative position with respect to the uniquely identified map object. So, the location reference may comprise:
unique map object reference, and
relative position.

The unique map object reference may for instance be formed by
feature class reference, and
feature identification,
   as explained above. It will however be understood that the unique map object reference may also be formed by another set of parameters that uniquely identify a map object within the digital map database. For instance, in case each map object in a digital map database has a unique feature identification, it may be sufficient that the unique reference is formed by a feature identification only. For other digital map databases, map objects are only uniquely identified by a feature identification within a certain feature class reference. In that case, the unique map object reference is formed by a feature identification and a feature class reference.

The relative position may be formed in many different ways, as explained above.

Communicating Third Party Information to Client

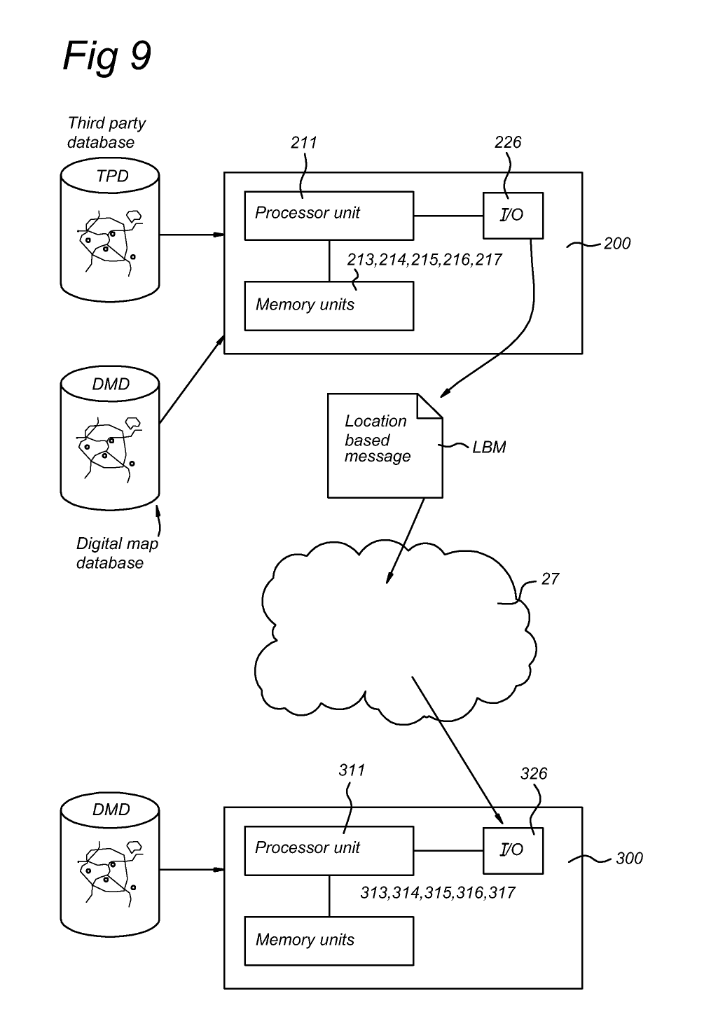

FIG. 9 schematically depicts a server computer system 200 and a client computer system 300, that each for instance may be formed as a computer system 1 explained with reference to FIG. 1. Both the server computer system 200 and the client computer system 300 are depicted schematically.

The server computer system 200 comprises a processor unit 211 for performing arithmetical operations. The processor unit 211 may be connected to memory units that may store instructions and data, such as a tape unit 213, a hard disk 214, a Read Only Memory (ROM) 215, an Electrically Erasable Programmable Read Only Memory (EEPROM) 216 and a Random Access Memory (RAM) 217. The memory units are schematically depicted as one block.

The memory units 213, 214, 215, 216, 217 may comprise program instructions readable for the processor unit 211, instructing the processor unit 211 to perform the methods as described below.

The server computer system 200 also comprises an input-output device (I/O) 226 that is arranged to communicate with other computer systems via a communication network 27.

The server computer system 200 has access to at least one digital map database DMD and third party information TPD that is to be encoded. The digital map database DMD and the third party information TPD are depicted as separate items in FIG. 9. However, it will be understood that the digital map database DMD and/or the third party database TPD may be stored in the memory units 213, 214, 215, 216, 217. However, they may also be on floppy disks 23 or DVDs or CD ROMs 24 readable by the server computer system 200 using one or more reading units (not shown). Of course the data may also be accessible via network 27 using input-output device (I/O) 226. However, it should be understood that there may be provided any number of memory units, input devices and read devices known to persons skilled in the art.

The client computer system 300 comprises a processor unit 311 for performing arithmetical operations. The processor unit 311 may be connected to memory units that may store instructions and data, such as a tape unit 313, a hard disk 314, a Read Only Memory (ROM) 315, an Electrically Erasable Programmable Read Only Memory (EEPROM) 316 and a Random Access Memory (RAM) 317. The memory units are schematically depicted as one block.

The memory units 313, 314, 315, 316, 317 may comprise program instructions readable for the processor unit 311, instructing the processor unit 311 to perform the methods as described below.

The client computer system 300 also comprises an input-output device (I/O) 326 that is arranged to communicate with other computer systems via a communication network 27.

The client computer system 300 has access to at least one digital map database DMD. The digital map database DMD is depicted as a separate item in FIG. 9. However, it will be understood that the digital map database DMD may be stored in the memory units 213, 214, 215, 216, 217. However, the DMD may also be stored on floppy disks 23 or DVDs or CD ROMs 24 readable by the client computer system 300 using one or more reading units (not shown). Of course the data may also be accessible via network 27 using input-output device (I/O) 326. However, it should be understood that there may be provided any number of memory units, input devices and read devices known to persons skilled in the art.

The server computer system 200 and the client computer system 300 are arranged to communicate with each other using input-output devices (I/O) 226, 326 as shown in FIG. 9.

The server computer system 200 is arranged to generate a location based message LBM. The processor unit 211 is further arranged to transmit the location based message LBM to the client computer system 300 via network 27 using input-output device 226. The client computer system 300 is arranged to receive such a location based message LBM using input-output device 326, decode the location based message LBM and store the location based message LBM in the memory units 313, 314, 314, 315, 316, 317.

Both the server computer system 200 and the client computer system 300 may be any type of computer system, and may also include in-vehicle navigation systems, (portable) personal navigation systems, mobile telephones, personal digital assistants (PDA), traditional ‘office computers’, smart telephones having a storage medium arranged to comprise a digital map database.

Generating Location Based Message

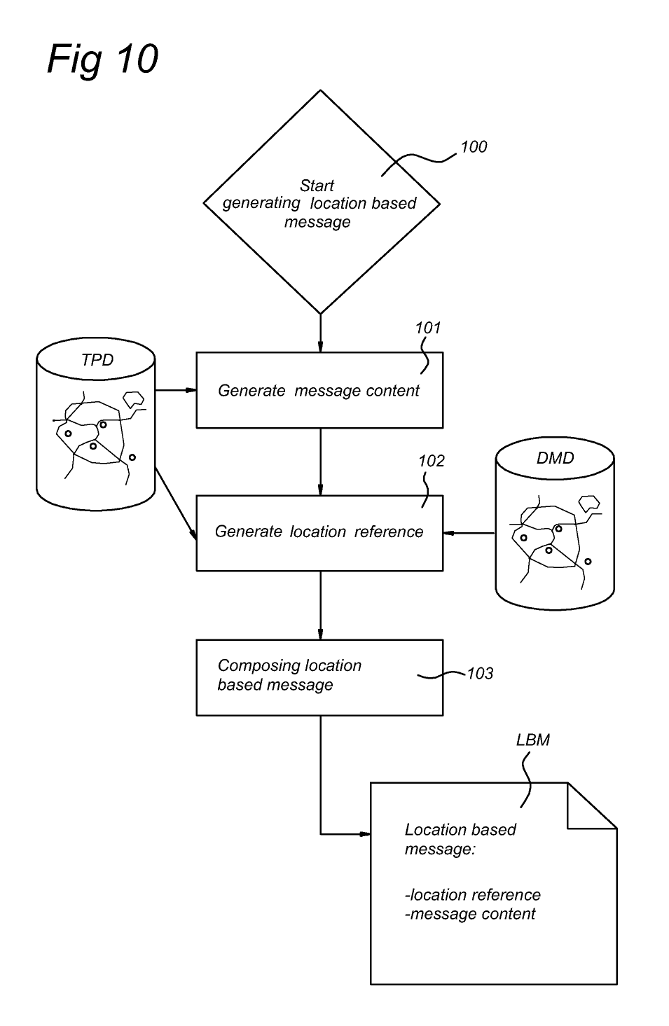

FIG. 10 schematically depicts a flow chart showing what actions may be performed by the server computer system 200 when generating a location based message LBM. The flow chart depicts the actions as may be performed by the server computer system 200.

According to FIG. 10, in a first action 100, the server computer system 200 starts generating a location based message LBM. In a next action 101 message content is read in by the server computer system 200 from the third party database TPD.

In a next action 102, a location reference is generated. This is done using location information from the third party database TPD and comparing this information with the digital map database DMD, as schematically indicated in FIG. 10. A detailed description of how action 102 is performed will be given below.

When both the message content and the location reference are generated, these two are combined to form the location based message LBM. Of course, additional information may be added to the location based message LBM. This may for instance be header information comprising a version reference and/or a database reference, as explained above.

Generating Location Reference

FIG. 10 showed the generation of a location based message LBM, which comprises an action 102: generating a location reference. FIG. 11 shows a flow chart, showing in more detail how such a location reference may be made.

Location references may be generated automatically, for instance using a server computer system 200 as described with reference to FIG. 9. A method for generating location references is described with reference to FIG. 11 schematically depicting a flow chart for generating a location reference. The method could also be referred to as encoding third party information or geo-coding third party information.

The flow chart of FIG. 11 will be explained using the examples 1-7 explained above.

Encoding Example 1

According to the first example, the location reference was 1 2005.1 1 7314 70, being a location reference referring to a hotel/motel being already present in the digital map database DMD, having feature identification 70. This location reference may be used to form a location based message LBM, communicating information of actual discount offers for a hotel as well as the menu for tonight.

According to FIG. 11, in a first action 120 the server computer system 200 starts generating the location reference. This may be initiated by a start command, for instance inputted by a user. This is done using input from the third party database TPB.

In a next action 121 it is determined whether or not the location the location reference is to be made for (hotel) is a line location. In this case, the location is a point location, so the answer is no.

In action 122, the server computer system 200 determines a reference point. In case the position to be located is a point location, the reference point is simply the point to be encoded. In case the location to be located is an area, the reference point may be the start point of the polygon defining the area. However, it may also be an other point of the area, for instance a midpoint of the area.

In a next action 123 the server computer system 200 determine if the reference point determined in the previous action coincides with a map object present in the digital map database DMD. In this case, the coordinates of the point for which the location reference is being determined matches the coordinates of a map object already present in the digital map database DMD. So, in action 124, the matching map object is retrieved from the digital map database DMD.

The match of the geometry may for instance be done by the server computer system 200 using a special algorithm. The algorithm may for instance define a search window around the coordinates of the point for which the location reference is being determined, e.g. from third party information, and may retrieve all map objects in this search window. Then, the distances between the coordinates of the point to be encoded and the coordinates of all the map objects within the search window are computed. If the shortest distance equals zero or is below a predetermined threshold, the coordinates of the point to be encoded are considered to coincide with the coordinates of the corresponding map object.

In case the distance between the third party information and the closest map object is above the threshold, the server computer system 200 may continue to action 132 and 133, as will be discussed below.

In case no coordinates are provided for the point for which the location reference is being determined, but only an address is provided, this address may be converted into coordinates by a technique called geo-coding, which is known to a skilled person.

In action 125 the server computer system 200 extracts version reference 1, database reference 2005.1, feature identification 70, feature class reference 7314 and possible additional information that may be used for the location reference. These parameters are to be added to the location reference, as already explained above.

In actions 126, 127 the server computer system 200 determines whether or not the coinciding map object is an area or line object. In this case, the answer to action 126 (area reference?) is no, as well as the answer to action 127 (line reference?). So, in a next action 128, the location reference can be composed, resulting in a location reference 129.

Encoding Example 2

According to the second example, third party information is available of a traffic jam matching a road element already in the digital map database. According to this example, the location reference is 1 2005.1 2 4110 43.

In this case, the outcome of action 121 is yes, as the third party information relates to a road element, which is a line location. Thus after action 121, the server computer system 200 proceeds with action 130, in which it is checked whether or not the third party information coincides with a linear map object already present in the digital map database DMD. This may be estimated by comparing the coordinates of the third party information with the coordinates of the database object. If no third party coordinates are available, an address or address range may be available for the third party information, to geocode the address information and compare the geometry with the map object geometry. The answer in this case is yes, so the server computer system 200 proceeds with action 124, already discussed above.

Via action 124, 125 and 126, the server computer system 200 reaches action 127, in which the server computer system 200 determines if the coinciding map object is an line object. In this example, the coinciding map object is a line object, so the server computer system 200 proceeds to action 131.

In action 131 the server computer system 200 calculates start and end offsets. In this example, the start of the third party information exactly matches the start node of the coinciding map object while the end exactly matches the end node. Thus there is a 100% overlap and no need to include start and end offsets explicitly into the location reference.

Finally in action 128 the location reference is composed, resulting in a location reference 129.

Encoding Example 3

According to the third example, the location reference is be: 1 2005.1 2 4110 78 43 52 85 50, referring to a traffic jam on more than one road element.

The encoding of this location reference is similar to the encoding of example 2, except that the action 124 finds three matching map objects with the feature identifications 78, 43, 52 and the action 131 determines that the start of the location reference is 85% percent away from the start node of map object 78, while the end of the location reference is 50% away from the start node of the map object 52. Thus, action 128 includes the feature identification from three map objects as well as the start and end offsets into the location reference.

Encoding Example 4

According to the fourth example the location reference is 1 2005.1 3 3110 222, being information about a thunder storm in a certain area. The encoding of this location reference is almost similar to the encoding of example 1, except for the fact that the answer to action 126 is yes, so actions 127 and 131 are omitted.

Encoding Example 5

According to the fifth example, the location reference is: 1 2005.1 1 4110 48 37 315, referring to the location of a public rest-room. Contrary to the previous examples, the third party information relates to a map object that doesn't coincide with a map object of the digital map database DMD. So, after actions 120, 121, 122, the answer to action 123 is no.

So, instead of finding the matching map object (action 124), in this case, the closest map object is determined in action 132, using information from the digital map database DMD. This may be done by the server computer system 200 using a special algorithm. The algorithm may for instance define a search window around the position of the third party information and retrieve all map objects in this search window. Then, the distance between the third party information and all the map objects within the search window are computed. The map object for which the shortest distance is computed is selected as the closest map object, in this case being map object having a feature identification 48. This may be estimated by comparing the coordinates of the third party information with the ones of the database object. If no third party coordinates are available, an address or address range may be available for the third party information, to geocode the address information and compare the geometry with the map object geometry. According to an alternative embodiment, the closest map object is determined by hand. The server computer system 200 may do so by presenting a view of a part of the digital map data DMD to a user, for instance via a display. In the displayed digital map data DMD the position of the third party information is displayed together with the nearby map objects. The user is then asked to select one of the map objects. The selected map object is considered to be the closest map object.

In case the distance between the third party information and the closest map object is zero, or below a predetermined threshold, the map object is considered as coinciding with the third party information. In that case, the server computer system 200 may proceed with action 124.

After action 132 is finished, the server computer system 200 proceeds with action 133, extracting version reference 1, database reference 2005.1 and feature identification of the closest map object 48, similar to action 125, described above.

In a next action 134, the relative position of the third party information is determined with respect to the closest map object determined in action 132. The relative position may be expressed in many different ways, such as for instance by a distance and an angle, or by a distance in a first direction, and a distance in a second direction. For action 134, information from the digital map database DMD is used. According to this example, the relative position is expressed by a distance being 37 metres and an angle being 315.

Finally, in action 128 the location reference 129 is composed.

Encoding Example 6

According to a further example, the location reference is: 1 2005.1 2 4110 42 49 180. When encoding this example, the answer to action 121 is yes, so the server computer system 200 proceeds to action 130. In this case, the public transportation network lines do not coincide with an already existing map object of the digital map database DMD. Therefore, the answer to action 130 is no, and the server computer system proceeds to action 135, in which a reference point is estimated. The reference point may simply be the start point of the line location to be encoded (e.g. public transportation network lines). However, of course, also another point of the line location to be encoded may be chosen as a reference point, for instance the endpoint or midpoint. The choice of the reference point may be indicated in the message content of the location-based message. When a reference point has been determined, the server computer system 200 proceeds to action 132, 133, 134, 128 and 129 as discussed above.

It will be understood that in case the scale and/or rotational orientation of the third party geometry is different from the scale and rotational orientation of the digital map database DMD, additional actions may be performed to identify a scale factor and a rotation factor, as discussed above. These possible additional actions are not shown in FIG. 11.

Encoding Example 7

In a further example, the location reference is: 1 2005.1 3 4110 42 49 180. In this case the server computer system 200 encodes the location reference by subsequently performing actions 120, 121, 122, 123, 132, 133, 134, 128, 129, which have all been discussed above.

Again, it will be understood that in case the scale and rotational orientation of the third party geometry is different from the scale and rotational orientation of the digital map database DMD, additional actions may be performed to identify a scale factor and a rotation factor, as discussed above. These possible additional actions are not shown in FIG. 11.

So, according to an embodiment, a method of decoding may comprise identifying a scale factor from the location reference. The scale factor takes into account a scale difference between the digital map database and the information. The method may further comprise applying the scale factor to the received information.

According to a further embodiment, the method of decoding may comprise identifying a rotation factor from the location reference. The rotation factor takes into account a rotational difference between the digital map database and the information. The method may further comprise applying the rotation factor to the received information.

Decoding Location Based Message

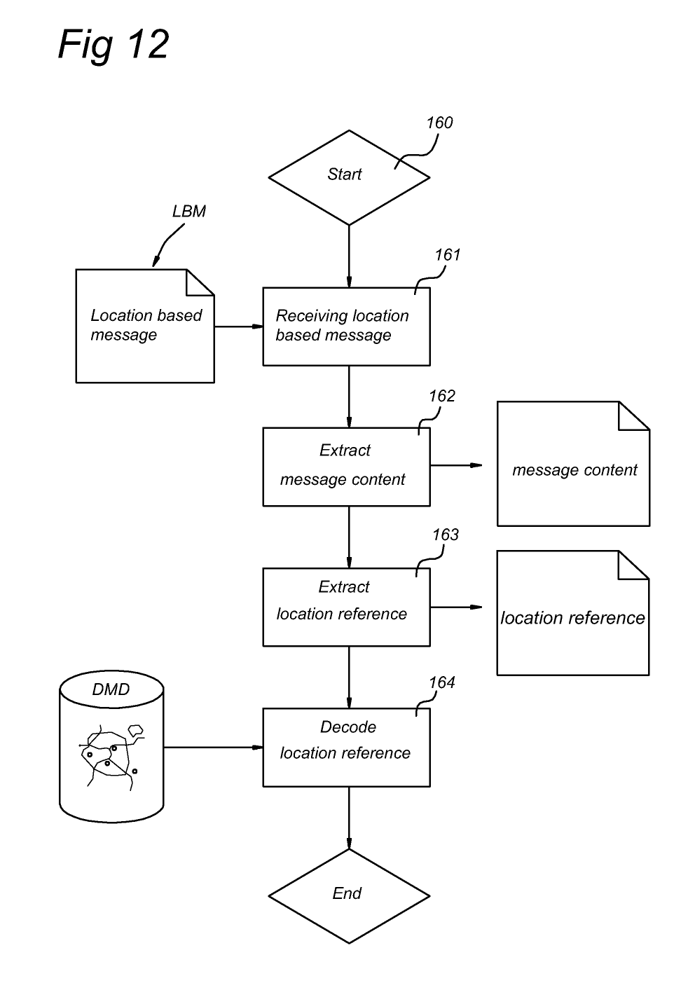

The server computer system 200 transmits the location based message LBM to a client computer system 300, as described above. The client computer system 300 receives the location based message LBM. Once the client computer system received the location based message LBM, the client computer system 300 starts to decode the location based message LBM. This is schematically shown in FIG. 12.

In a first action 160, the client computer system 300 starts. In a next action 161, the client computer system 300 receives the location based message LBM, as indicated in FIG. 12. The client computer system 300 receives the location based message LBM using input-output device 326, described above.

In next actions 162,163 the client computer system 300 respectively extracts the message content and the location reference from the location based message LBM. Once the location reference is extracted from the location based message LBM, the client computer system 300 starts to decode the location reference in action 164. The details of the decoding are discussed below. For decoding the location reference, the client computer system 300 uses input from the digital map database DMD.

Decoding Location Reference

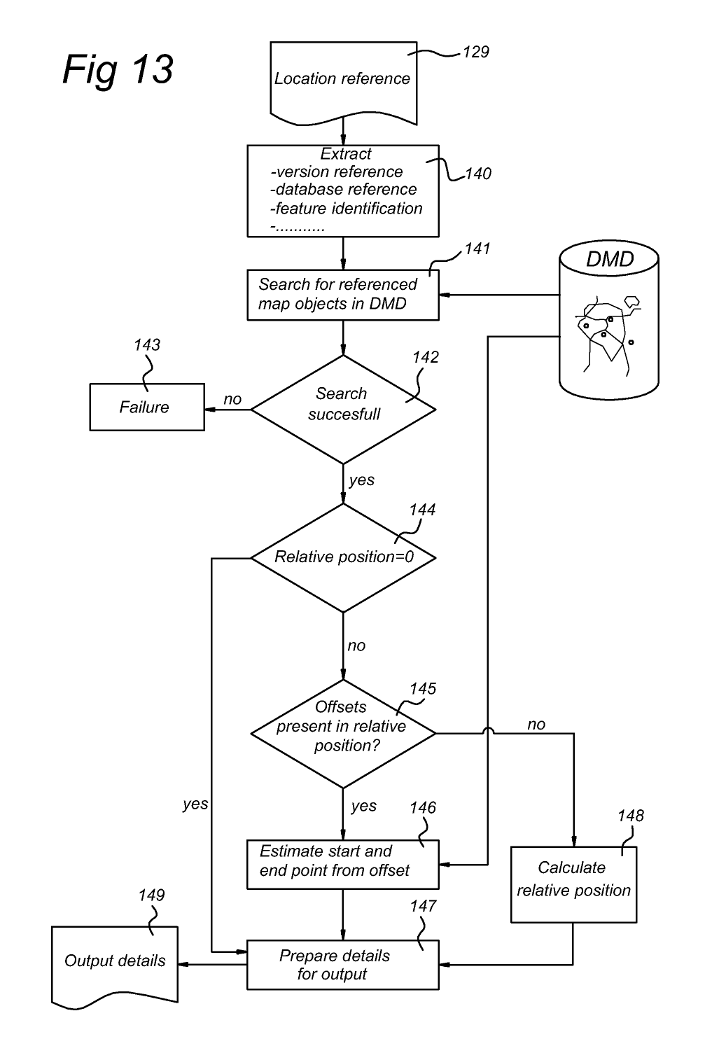

The actions as may be performed by the client computer system 300 for receiving and decoding the location based message LBM are described above, with reference to FIG. 12, including action 164 for decoding the location reference. FIG. 13 schematically depicts the actions as may be performed by the client computer system 300 when executing action 164 in more detail.

According to FIG. 13, in a first action 140 the location reference 129 is loaded and the relevant information is extracted from it, such as the version reference, the database reference, the external location type, the feature class reference, the feature identification and the relative position.

In a next action 141, the client computer system 300 searches for the map objects in the digital map database DMD, the location reference refers to. In case no corresponding map objects are found in the digital map database, the search is not successful and the outcome to action 142 is no, resulting in a failure 143.

Of course, the decoding of the location reference also fails when the version reference and/or the database reference do not meet the decoding version and/or digital map database version used in the client computer system 300, although not shown in FIG. 13.

However, in case the search is successful, the outcome of action 142 is yes and the client computer system 300 proceeds to action 144. Further actions 144, 145, 146, 147, 148, 149 are discussed below with reference to the examples already discussed above.

Decoding Example 1

According to the first example, the location reference is 1 2005.1 1 7314 70, being a location reference referring to a hotel/motel being already present in the digital map database DMD, having feature identification 70. This location reference may be used to form a location based message LBM, communicating information of actual discount offers for a hotel as well as the menu for tonight.

According to FIG. 13, after having passed actions 140, 141, 142 discussed above, the client computer system 300 proceeds with action 144, in which it determines whether there is a precise match of the location reference with map objects from the digital map database DMD.

According to example 1, this is the case, so the outcome to action 144 is yes and the client computer system 300 proceeds with action 147.

In action 147, the client computer system 300 prepares output details 149 of the third party information ready for use in the client computer system 300. The third party information may for instance be added to the digital map database DMD.

According to a further embodiment, the client computer system 300 may determine if the relative position is below a predetermined threshold, instead of checking if the relative position equals zero.

Decoding Example 2

According to the second example, third party information is available of a traffic jam matching a road element already in the digital map database. According to this example, the location reference is 1 2005.1 2 4110 43.

As can be seen in FIG. 13, after having executed actions 140, 141, 142, the client computer server 300 proceeds with action 144, in which it determines if the relative position equals zero. In this case, again, the relative position is zero, and the client computer system 300 proceeds with action 147, as discussed above, resulting in output details 149.

The location reference does not contain any relative position such as start and end offsets. This means that the start of the location reference coincides with the start node of map object 43, while the end of the location reference coincides with the end node of the same map object, i.e. they are matching precisely.

Decoding Example 3

According to the third example, the location reference is be: 1 2005.1 2 4110 78 43 52 85 50, referring to a traffic jam on more than one road element, where start and end of the location reference do not precisely match the start and end of the involved map objects.

As can be seen in FIG. 13, after having executed actions 140, 141, 142, the client computer server 300 proceeds with action 144, in which it determines if the relative position equals zero. In this case the relative position equals zero. The outcome of action 144 is no, as the relative position includes start and end offsets, and the client computer system 300 proceeds with action 145, in which it is determined whether or not an offset is present in the relative position. According to this example, the outcome of action 145 is yes, so action 146 is performed. In action 146, the start and end point are estimated. From the start offset=85% and end offset=50% as provided by the location reference, the precise start and end points are estimated. In this example, the start point of the location reference is 85% percent away from the start node of the first map object 78, while the end point of the location reference is 50% away from the start node of the last map object 52.

As discussed above, action 147 is resulting in output details 149.

Decoding Example 4

According to the fourth example the location reference is 1 2005.1 3 3110 222, being information about a heavy thunderstorm in a certain area.

The decoding of this location reference is equal to the decoding of example 3, except for the fact that the coinciding map object is an area. After action 144, the client computer system 300 proceeds with action 147, as discussed above, resulting in output details 149.

Decoding Example 5

According to the fifth example, the location reference is: 1 2005.1 1 4110 48 37 315, referring to the location of a public rest-room. Contrary to the previous examples, the third party information relates to a map object that doesn't coincide with a map object of the digital map database DMD.

According to FIG. 13, after having passed actions 140, 141, 142 discussed above, the client computer system 300 proceeds with action 144, in which it determines if the relative position equals 0.

According to this example, the relative position is not equal to 0, so the outcome to action 144 is no. As a result, the client computer system 300 proceeds with action 145, in which the client computer system checks if the relative position includes start and end offsets. In this case, this is not the case, so the result of action 145 is no.

In a next action, the client computer system 300 proceeds with action 148, in which it computes the relative position, using the parameters from the relative position in the location reference: 37 metres and 315°. After action 148, the client computer system ends with action 147 discussed above.

Decoding Example 6

According to a further example, the location reference is: 1 2005.1 2 4110 42 49 180, being information about the relative position of a railroad network.

According to FIG. 13, after having passed actions 140, 141, 142 discussed above, the client computer system 300 proceeds with action 144, in which it determines if the relative position equals 0.

According to this example, the relative position is not equal to 0, so the outcome to action 144 is no. As a result, the client computer system 300 proceeds with action 145, in which the client computer system checks, if the relative position includes start and end offsets. In this case, this is not the case, so the result of action 145 is no.

In a next action, the client computer system 300 proceeds with action 148, in which it computes the relative position, using the parameters from the relative position in the location reference: 49 metres and 180°. After action 148, the client computer system ends with action 147 discussed above.

Decoding Example 7

In a further example, the location reference is: 1 2005.1 3 4110 42 49 180, being a location reference for weather information. Like the previous example, the third party information relates to a map object that does not coincide with a map object of the digital map database DMD.

According to FIG. 13, after having passed actions 140, 141, 142 discussed above, the client computer system 300 proceeds with action 144, in which it determines if the relative position equals 0.

According to this example, the relative position is not equal to 0, so the outcome to action 144 is no. As a result, the client computer system 300 proceeds with action 145, in which the client computer system checks if the relative position includes start and end offsets. In this case, this is not the case, so the result of action 145 is no.

In a next action, the client computer system 300 proceeds with action 148, in which is computes the relative position, using the parameters from the relative position in the location reference: 49 metres and 180°. After action 148, the client computer system ends with action 147 discussed above.

For the purpose of teaching the invention, preferred embodiments of the method and devices of the invention were described. It will be apparent for the person skilled in the art that other alternative and equivalent embodiments of the invention can be conceived and reduced to practice without departing from the true spirit of the invention, the scope of the invention being only limited by the annexed claims.

1. Method for generating a location reference for mapping information to a position within a digital map database, the digital map database including map objects having unique map object references associated therewith, the method comprising:
selecting a map object in the digital map database based on the information;
extracting a unique map object reference of the selected map object;
generating the location reference comprising the unique map object reference of the identified map object;
and
determining a relative position of the position in the digital map database the information relates to with respect to the selected map object, the location reference further including the relative position.

2. Method according claim 1, wherein the selected map object in the digital map database is the map object in the digital map database that is nearest to the position in the digital map database the information refers to.

3. Method according to claim 1, wherein the relative position may be zero, indicating that the position in the digital map database the information refers to coincides with the selected map object or the distance between the position in the digital map database the information refers to and the selected map object is below a predetermined threshold.

4. Method according to claim 1, wherein the relative position of the information with respect to the identified map object is expressed in a distance from the selected map object and an angle identifying a direction from the selected map object.

5. Method according to claim 1, wherein the relative position of the information with respect to the selected map object is expressed in a first distance from the selected map object in a first direction and a second distance from the selected map object in a second direction, the first direction being different from the second direction.

6. Method according to claim 1, wherein the method further comprises determining a scale factor taking into account a scale difference between the digital map database and the information, and the location reference further comprises the scale factor.

7. Method according to claim 1, wherein the method further comprises determining a rotation factor taking into account a rotational difference between the digital map database and the information, and the location reference further comprises the rotation factor.

8. Method according to claim 1, wherein the selected map object is a line feature, and where the information is coinciding with a fraction of this line feature, and wherein the location reference comprises an indication of the fraction of the line feature the information coincides with.

9. Method according to claim 8, wherein the indication of the fraction of the line feature the information coincides with is expressed in a first offset from a start node or from an end point of the selected map object and/or in a second offset from the start node or from the end point of the selected map object along the line feature.

10. Method according to claim 8, wherein more than one line feature is selected, and the indication is with respect to a first selected line feature and with respect to a second selected line feature.

11. Method according to claim 1, wherein the unique map object reference of the selected map object comprises a feature identification.

12. Method according to claim 1, wherein the unique map object reference of the selected map object further comprises a feature class reference.

13. Method according to claim 1, wherein the location reference further comprises header information, wherein the header information may comprise a version reference and a database reference.

14. Method according to claim 1, wherein the location reference further comprises an external location type, identifying if the information relates to a point, such as a point of interest, a line, such as a road element, or an area, such as a country.

15. Method according to claim 1, wherein the selected map object is one of a point feature, such as a point of interest junction, a line feature such as a road element and an area feature such as an administrative area, etc.

16. (canceled)

17. Method for generating a location based message, the location based message comprising a message content based on the information and a location reference, where the location reference is generated according to claim 1.

18. (canceled)

19. Method for mapping information to a position within a digital map database, the digital map database including map objects having unique map object references associated therewith, the method comprising:
loading a location reference including a unique map object reference of a map object;
identifying a map object in the digital map database based on the unique map object reference;
mapping the information to the digital map database based on the location reference, wherein the location reference further includes a relative position; and
identifying the position within the digital map database based on the identified map object in the digital map database and the relative position.

20.-24. (canceled)

25. Computer system for generating a location reference for mapping information to a position within a digital map database, the computer system comprising:
a processor unit; and
memory units, the processor unit being arranged to communicate with the memory units, the memory units being arranged to comprise a digital map database comprising map objects having unique map object references associated therewith, the computer system being arranged to
load information for which the location reference is to be generated,
select a map object in the digital map database based on the information,
select a unique map object reference from the digital map database on the selected map object,
generate the location reference comprising the unique map object reference of the identified map object, and
determine a relative position of the information with respect to the selected map object, the location reference further including the relative position.

26.-45. (canceled)

46. Computer program, when loaded on a computer arrangement, arranged to perform the methods according to claim 1.

47. Data carrier, comprising a computer program according to claim 46.
